(19) United States
(12) Patent Application Publication
(10) Pub. No.: US 2004/0057730 A1
(43) Pub. Date: Mar. 25, 2004

(54) Control processor for use with a transceiver in an optical wireless network

(76) Inventors: Harry Littlejohn, Highland Village, TX (US); Eric McMurry, Richardson, TX (US); Steven D. Roemerman, Highland Village, TX (US)

Correspondence Address: SLATER & MATSIL, L.L.P., 17950 PRESTON RD, SUITE 1000, DALLAS, TX, 75252-5793, US

(21) Appl. No.: 10/665,852

(22) Filed: Sep. 18, 2003

Related U.S. Application Data
(60) Provisional application No. 60/411,809, filed on Sep. 18, 2002.

(51) Int. Cl. H04B 10/00

(52) U.S. Cl. 398/156

(57) ABSTRACT

For use with a transceiver employing an inertial sensor and capable of transmitting a laser beam to an other transceiver, a beam control processor and method of providing beam steering commands for a transmitter element of the transceiver. In one embodiment, the beam control processor includes a line-of-sight estimation subsystem configured to provide a line-of-sight pointing vector of the laser beam based on acceleration inertial motion data provided by the inertial sensor. The beam control processor also includes a line-of-sight control subsystem configured to generate beam steering commands for the transceiver as a function of the line-of-sight pointing vector.

This application claims the benefit of U.S. Provisional Application No. 60/411,809, filed on Sep. 18, 2002, entitled “Novel Extensions of Optical Wireless Networking,” which application is hereby incorporated herein by reference.

### CROSS REFERENCE TO RELATED APPLICATIONS

This application relates to the following co-pending and commonly assigned patent applications: U.S. patent application Ser. No. 10/409,918, entitled “Wireless Optical System and Method for Point to Point High Bandwidth Communications,” filed Apr. 9, 2003, to McMurry, et al.; U.S. patent application Ser. No. 10/090,249, entitled “Wireless Optical System for High Bandwidth Communications,” filed Mar. 4, 2002, to Volpi, et al.; and U.S. patent application Ser. No. 10/090,270, entitled “Wireless Optical System for Multidirectional High Bandwidth Communications,” filed Mar. 4, 2002, to Volpi, et al., which applications are hereby incorporated herein by reference.

### TECHNICAL FIELD

The present invention relates generally to communication networks and, more particularly, to a transceiver and related method for transmitting and receiving high bandwidth signals in an optical wireless network for point-to-point communications.

### BACKGROUND

A deployment of optical wireless networks creates unique challenges that other communication networks generally do not encounter. High bandwidth optical wireless networks generally employ at least two similar optical wireless transceivers (also referred to as “transceivers”) in a point-to-point configuration. In a point-to-point configuration employable with a local area network, one transceiver may be coupled to the network and an other transceiver may be coupled to a user computer, terminal or similar network compatible equipment. The user information (typically in a packet format) is transmitted between the transceivers using focused laser beams capable of very high bandwidth communications.

The use of directed laser beams to transmit information through free space without the use of fiber optics typically requires an unobstructed line-of-sight and should not represent a safety hazard to people within reach of the laser beam. Of importance, the optical wireless links should be reliable and provide about 99.99% availability in the presence of incidental obstructions, vibration or shock, and physical motion of a transceiver relative to the other transceiver (also referred to as “relative base motion”). Techniques should be provided to compensate for the disturbances in order to maintain the laser beam's accurate alignment between the two transceivers.

Typically, forces applied to one (or both) of the transceivers result in a translation or rotation of the established line-of-sight causing the laser beam to move off a center of a receiver aperture of a transceiver and creating an angular misalignment of the laser beam relative to the desired line-of-sight. A displacement of the laser beam relative to the center of the receiver aperture is referred to as “beam centering errors.” The angular errors are referred to as “beam orthogonality errors.” To achieve proper and reliable operation of the optical wireless link, each transceiver should adjust a pointing angle of the transmitted laser beam to remove the beam centering error and adjust an orientation of the receiver aperture to align the received laser beam with an aperture optical axis. It is not necessary to attempt to correct the actual inertial position of either transceiver, just the rotational orientation to keep both transceiver optical axes pointed along the line-of-sight therebetween.

A transmitter element of each transceiver contains a modulated light source and a form of steerable mirror or a multi-axis servo-controlled mounting platform for directing the laser beam toward an other or partner transceiver. The receiver element, which may be fixed or may also contain a steerable optics assembly, captures the laser energy from the transmitting transceiver and recovers the modulation signals. Other transceiver systems may employ a common multi-axis servo-controlled mounting platform for both the transmitter and receiver elements to steer the transmitted laser beam and receiver aperture as a single unit.

There have been several attempts in the past to determine the beam centering error of the received laser beam followed by sending correction requests to the transceiver that is transmitting the laser beam. For instance, beam centering errors have been determined directly from the quality of the data detected at the receiver aperture. Additionally, there have been attempts to measure the misalignment using additional optical elements in the receiver aperture.

In either case, however, each transceiver determines the beam centering errors and relays that information to the other transceiver which uses the information to determine the necessary corrections to the pointing angles of the transmitted laser beam. This technique allows beam centering errors to propagate prior to performing the necessary compensation which results in degraded performance. To reduce the impact on communication quality, the currently available systems use larger laser beam diameters and increase the size of the receiver aperture to minimize the effects of uncompensated motion. The systems also employ massive, extremely rigid, and heavy mounting structures to minimize the effects of relative base motion or vibration on the optical wireless links. These techniques greatly increase the complexity, weight, and cost of present optical systems and subsystems which inhibit a deployment thereof into many high volume network applications that are both size and cost sensitive. To provide effective solutions for networking applications, the transceiver should be small, light weight, and low cost yet still provide highly reliable, high bandwidth data communications.

Regarding inertially stabilized pointing systems, currently available solutions for stabilizing a pointing system against relative base motion include two-axis gimbaled platforms carrying the transceiver, a control processor for stabilization algorithms, and control loops and inertial sensors measuring forces applied to a system housing. While the aforementioned solution is viable, it typically requires large, expensive inertial measurement systems that operate over a wide range of motion. As a result, the components employed for measurement and control require large sturdy mounting structures and consume considerable power for operation.

Accordingly, what is needed in the art is a transceiver and related method that resolves the misalignment errors between a plurality of transceivers communicating over an optical wireless link that overcomes the deficiencies of the prior art.

### SUMMARY OF THE INVENTION

These and other problems are generally solved or circumvented, and technical advantages are generally achieved, by embodiments of the present invention as set forth herein. In one embodiment, a transceiver and related method of maintaining an available, reliable optical wireless link between two transceivers is provided by adjusting an angular orientation of the transmitted laser beam of a transceiver to compensate for the effects of vibration or relative base motion. Additionally, a receiver aperture of an other or partner transceiver may be adjusted to further compensate for the effects of vibration or relative base motion.

As mentioned above, currently available systems attempt to provide stable optical wireless links by isolating the transceiver from the base motion or vibration with large, highly rigid mounting structures. A residual beam motion is accommodated by increasing the size, power, weight and complexity of the optical transmitter and receiver elements of the transceiver. By oversizing the optical elements, residual base motions have little effect on the quality of the data transmitted over the optical wireless link. The aforementioned approach, however, may lead to very large, heavy, and costly transceivers that are not compatible with applications employing a large number of transceivers deployed across an optical wireless network. The currently available solutions are best suited for carrier class infrastructure deployments that can accommodate both the size and cost.

The system and method of the present invention provides for smaller, lighter weight, and lower cost transceivers that compensate for both beam centering and orthogonality errors by sensing a vibration or motion with inertial sensors. Incorporating the principles of the present invention into U.S. patent application Ser. No. 10/409,918 entitled “Wireless Optical System and Method for Point to Point High Bandwidth Communications” to McMurry, et al., for instance, provides a stable optical wireless link by, in one advantageous embodiment, controlling the angular orientation of the transmitter and receiver elements co-linearly with an optical line-of-sight between two transceivers. The small, low cost inertial sensors are combined with the closed control loop tracking techniques such that each transceiver may implement corrective pointing commands for the respective transmitter and receiver elements using base motion measurements of either transceiver. The closed control loop tracking techniques allow each transceiver to determine the beam centering errors on the respective receiver element and then forward that information to the other transceiver that is controlling the transmitted laser beam.

In accordance with the principles of the present invention, each transceiver can sense a base motion and apply corrective commands to the transmitter and receiver elements to compensate for the motion that provides the beam centering and orthogonality errors. Each transceiver then determines the residual line-of-sight motion and provides corrections to the transmitter and receiver element orientations to maintain the optical laser beam along the line-of-sight therebetween. Thus, the transceiver of the present invention enables an optical wireless link to maintain a higher quality and reliable optical wireless link using relative line-of-sight stabilization.

The system of the present invention can accommodate the cost effectiveness and reliability needs of optical wireless networks by using a small, low cost, and low power micro-machined accelerometer or gyroscopic devices as inertial sensors. Each transceiver has a “local control loop” to compensate for vibration and relative base motion effects on the transmitted laser beam and to compensate for rotational motion relative to the laser beam received from an other transceiver. The local control loop employs measurements from the inertial sensor combined with beam centering errors associated with the transceiver. Residual base motion data as well as other information is provided by an other transceiver using a second “outer control loop” between the two transceivers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an embodiment of portions of an optical wireless network that provides an environment for a transceiver constructed according to the principles of the present invention;

FIG. 2 illustrates a block diagram of an embodiment of portions of an optical wireless network that provides an environment for a transceiver constructed according to the principles of the present invention;

FIGS. 3A to 3C illustrate diagrams demonstrating effects of relative base motion between two transceivers in an environment of an optical wireless network;

FIG. 4 illustrates a block diagram of an embodiment of an inertial stabilization platform employable with a transceiver;

FIG. 5 illustrates a block diagram of an embodiment of a transceiver constructed according to the principles of the present invention;

FIG. 6 illustrates a block diagram of an embodiment of a transmitter element of a transceiver constructed according to the principles of the present invention;

FIG. 7 illustrates a block diagram of an embodiment of a receiver element of a transceiver constructed according to the principles of the present invention;

FIG. 8 illustrates a block diagram of another embodiment of a receiver element of a transceiver constructed according to the principles of the present invention;

FIG. 9 illustrates a block diagram of an embodiment of a control processor of a transceiver constructed according to the principles of the present invention;

FIG. 10 illustrates a block diagram of an embodiment of a beam control processor of a control processor of a transceiver constructed according to the principles of the present invention; and

FIG. 11 illustrates a block diagram of an embodiment of a data processor of a transceiver constructed according to the principles of the present invention.

### DETAILED DESCRIPTION OF ILLUSTRATIVE EMBODIMENTS

The making and using of advantageous embodiments of the present invention are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

An advantageous embodiment of a transceiver employing inertially stabilized optical systems and subsystems provides for reliable optical communications with high bandwidth and extended range between two access points in an optical wireless network. It is noted, however, that additional embodiments exist as outlined herein and additional ones as one skilled in the art will readily appreciate. Specific examples of components, signals, messages, protocols, and arrangements described herein are presented for illustrative purposes only and are not intended as limitations thereof.

The transceivers according to the present invention provide for a stable optical wireless link therebetween employable to replace Category 5 or 5e networking cable in an Ethernet-based local area network at distances up to, for instance, 100 meters. A significant advantage associated with the principles of the present invention is the ability to use low cost, small, low power components to achieve a stable line-of-sight for the laser beams implementing the bi-directional optical wireless link. In an advantageous embodiment, each transceiver employs two closed loop control techniques to adjust the point angles of the transmitted laser beam and the angular orientation of the receiver element in order to compensate for vibration or relative base motion of the two transceivers.

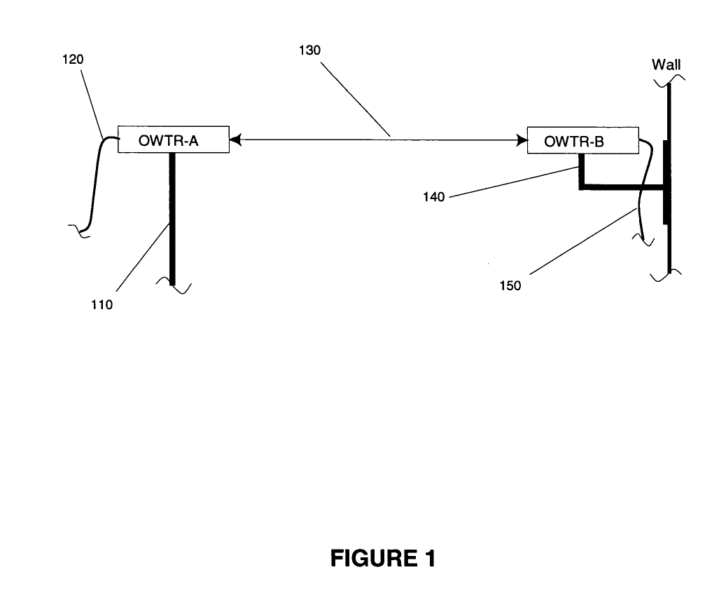

Referring initially to FIG. 1, illustrated is a block diagram of an embodiment of portions of an optical wireless network that provides an environment for a transceiver constructed according to the principles of the present invention. The optical wireless network includes two access points embodied in a first transceiver (also referred to as a “transceiver or local transceiver”) OWTR-A and a second transceiver (also referred to as “an other or partner transceiver”) OWTR-B. Of course, for the purposes of discussion herein, the second transceiver OWTR-B may assume a role as the “transceiver or local transceiver” and the first transceiver OWTR-A may assume a role as the “an other or partner transceiver.”

The first transceiver OWTR-A is installed at a user location on a pedestal mount 110. At this location, user data communication or computer equipment is connected via a first wired link 120 to the first transceiver OWTR-A that provides connectivity to a local area network. The first and second transceivers OWTR-A, OWTR-B communicate over an optical wireless link 130 providing bi-directional optical data signals therebetween. The second transceiver OWTR-B serves as a network access device and may be installed adjacent to a network wiring closet using a wall mount bracket 140. A connection to the local area network (e.g., an Ethernet-based local area network) is through a second wired link 150 connected to network switching or routing equipment.

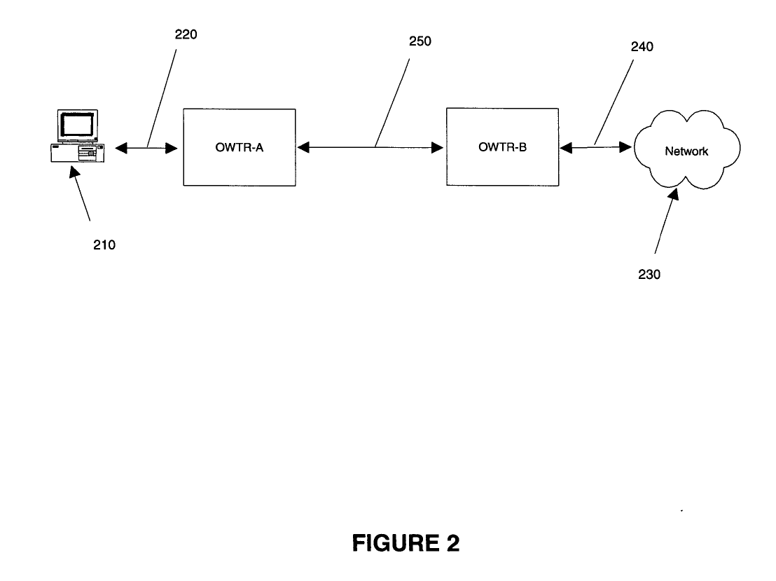

Turning now to FIG. 2, illustrated is a block diagram of an embodiment of portions of an optical wireless network that provides an environment for a transceiver constructed according to the principles of the present invention. A user computer 210 is in communication with a first transceiver OWTR-A of the optical wireless network via a wired connection illustrated by a first wired link 220. Similarly, a second transceiver OWTR-B of the optical wireless network is in communication with a communication network 230 via a wired connection illustrated by a second wired link 240. In the illustrated embodiment, the first transceiver OWTR-A and the second transceiver OWTR-B communicate via optical signals over an optical wireless link 250.

Again, relative to the first transceiver OWTR-A, the second transceiver OWTR-B is a “partner transceiver.” Similarly, relative to the second transceiver OWTR-B, the first transceiver OWTR-A is the “partner transceiver.” In the illustrated embodiment, the optical wireless link 250 carries optical signals transmitted between the first and second transceivers OWTR-A, OWTR-B, respectively. Thus, the user computer 210 may communicate with the communication network 230 via the first and second transceivers OWTR-A, OWTR-B over the optical wireless link 250.

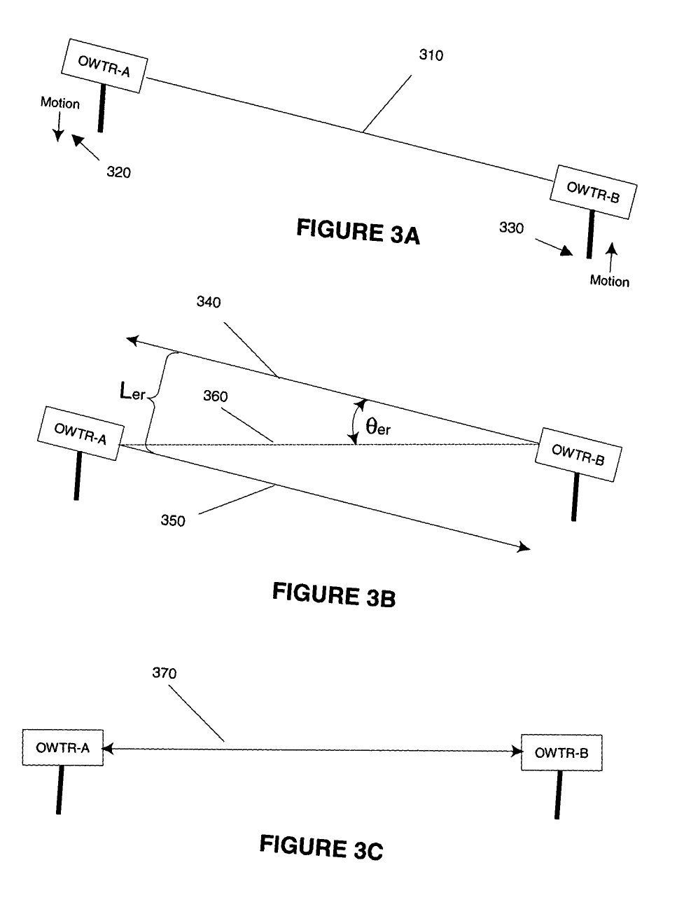

Turning now to FIGS. 3A to 3C, illustrated are diagrams demonstrating effects of relative base motion between two transceivers in an environment of an optical wireless network. In FIG. 3A, first and second transceivers OWTR-A, OWTR-B have established an optical wireless link 310 along a line-of-sight (herein also referred to as “LOS”) optical path. The first transceiver OWTR-A is subject to random forces that create base motion (designated by 320) and the second transceiver OWTR-B is acted on by other forces that result in a different base motion (designated by 330).

As demonstrated in FIG. 3B, the effect of the base motions 320, 330 is to displace the first and second transceivers OWTR-A, OWTR-B thereby causing transmitted laser beams (designated 340, 350, respectively) to no longer co-align with a line-of-sight axis 360. As a result, a set of errors are created, namely, a beam centering error Lₑᵣ and beam orthogonality errors θₑᵣ. The system of the present invention generates corrective signals to re-position the transmitted laser beam and a receiver aperture of a receiver element of the first and second transceivers OWTR-A, OWTR-B to re-align with an optical line-of-sight 370, as demonstrated in FIG. 3C. A closed control loop operation in accordance with the principles of the present invention employs measurements of the pending base motions 320, 330 to reduce the beam centering and orthogonality errors Lₑᵣ, θₑᵣ thereby stabilizing the transmitted laser beams 340, 350 on the line-of-sight 370 between the first and second transceivers OWTR-A, OWTR-B.

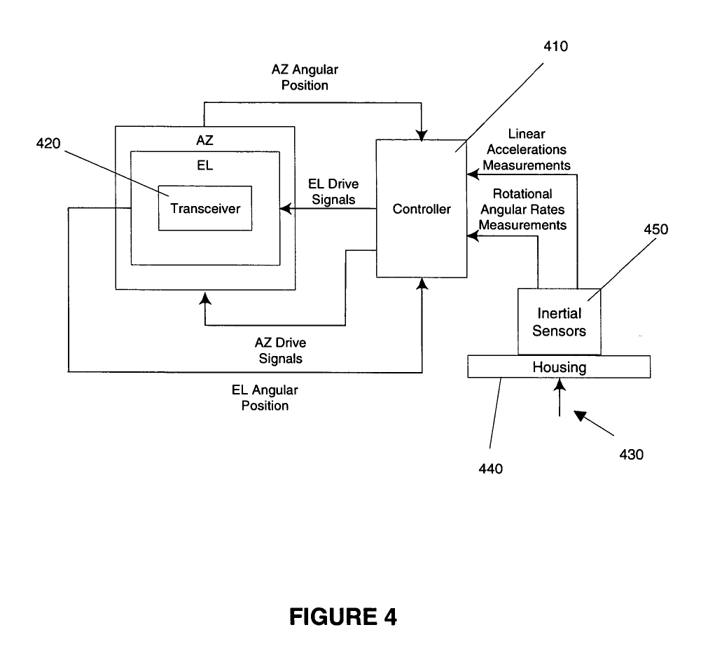

Turning now to FIG. 4, illustrated is a block diagram of an embodiment of an inertial stabilization platform employable with a transceiver. The inertial stabilization platform is formed by a two-axis gimbaled platform with an inner gimbal being an elevation axis (hereinafter referred to as an “elevation axis gimbal”) EL and an outer gimbal being an azimuth axis (hereinafter referred to as an “azimuth axis gimbal”) AZ. A controller 410 provides a closed control loop control of the azimuth and elevation axis gimbals AZ, EL to maintain a transceiver 420 at a desired angular orientation.

Forces (designated 430) applied to a housing 440 cause motions that are measured by inertial sensors 450 and provided to the controller 410 as an input to a stabilization algorithm. Measurements of linear accelerations and rotational angular rates are collected by the inertial sensors 450. The controller 410 monitors an angular position of the azimuth axis gimbal AZ and supplies azimuth axis gimbal drive signals to force the azimuth axis gimbal AZ to the desired rotational position. Similarly, the controller 410 monitors an angular position of the elevation axis gimbal EL and supplies elevation axis gimbal drive signals to force the elevation axis gimbal EL to the desired rotational position.

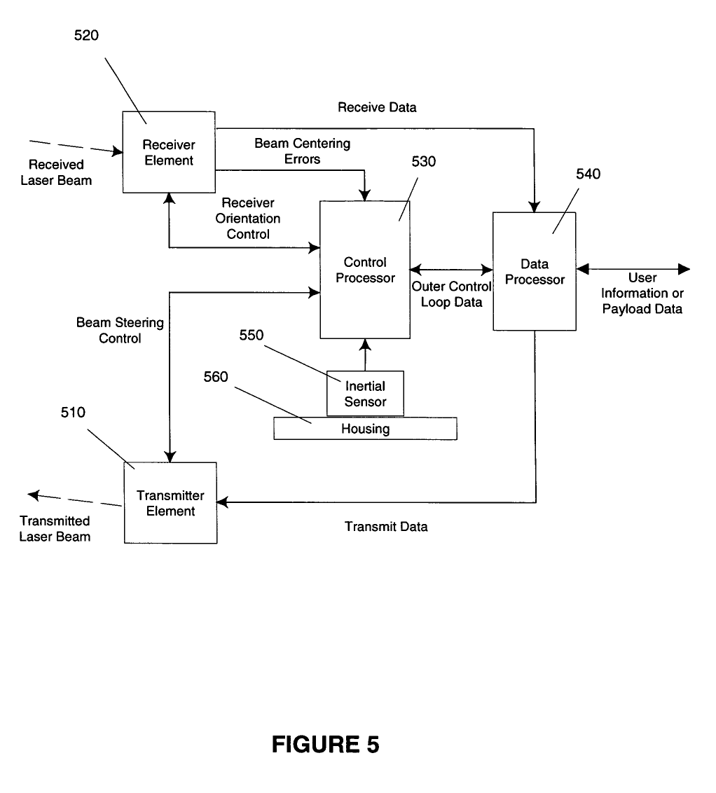

Turning now to FIG. 5, illustrated is a block diagram of an embodiment of a transceiver constructed according to the principles of the present invention. The transceiver includes a transmitter element 510, a receiver element 520, a control processor 530, a data processor 540, and an inertial sensor 550 coupled to a housing 560. The inertial sensor 550 may be embodied in two-to-three axis accelerometers mounted to the housing 560. If the transceiver is subject to rotational motion, the inertial sensor 550 may also include angular rate sensing gyroscopic sensors. Of course, the inertial sensor 550 may employ, for instance, small, low cost, low power semiconductor accelerometers and gyroscopics based on micro-electro mechanical systems technology. It is also within the broad scope of the present invention to employ an inertial sensor 550 that accommodates conventional accelerometers or gyroscopic devices such as those used in more expensive commercial and military equipment.

The data processor 540 of the transceiver processes user information or payload data that is carried over an optical wireless link. Outbound or transmit data is routed to the transmitter element 510 that modulates a transmitted laser beam. Similarly, information on a received laser beam is demodulated and routed as receive data via the data processor 540 for processing and, ultimately, transmission. The data processor 540 also processes outer control loop data thereby allowing control processors of a plurality of transceivers to share pointing and stability information. For a better understanding of a data processor, see U.S. patent application Ser. No. 10/409,918 entitled “Wireless Optical System and Method for Point to Point High Bandwidth Communications” to McMurry, et al.

The control processor 530 provides a beam steering control for the transmitter element 510 that sends drive signals and monitors pointing angles of a two-axis mirror element in the transmitter element 510. For the receiver element 520, the control processor 530 provides a receiver orientation control for controlling a two-axis rotation actuation mechanism in the receiver element 520. In addition to supplying drive signals and monitoring receiver orientation angles, the control processor 530 may also monitor beam centering errors of the received laser beam. Additional sensors may be included in a receiver aperture of the receiver element 520 to measure beam centering errors independent of the received data stream.

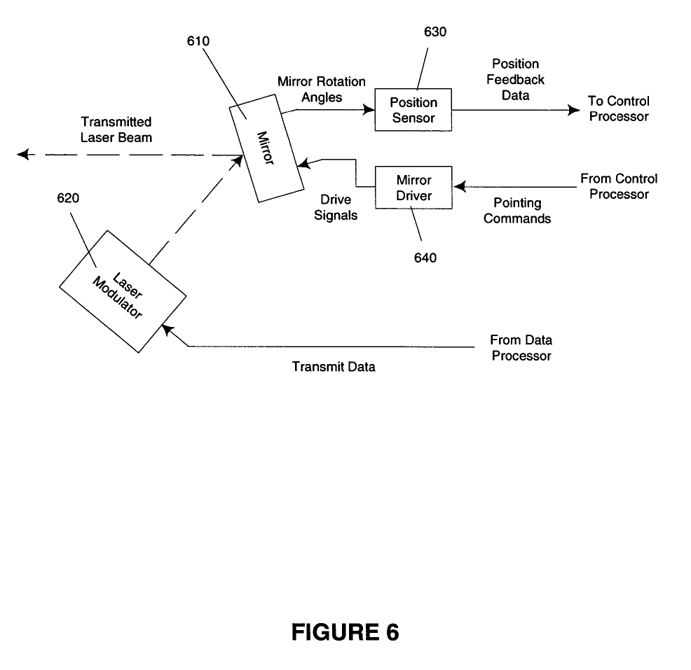

Turning now to FIG. 6, illustrated is a block diagram of an embodiment of a transmitter element of a transceiver constructed according to the principles of the present invention. A mirror (e.g., a two-axis, steerable mirror) 610 of the transmitter element is used to control an optical axis of a transmitted laser beam generated by a laser modulator 620. Transmit data from a data processor is modulated onto a laser beam in the laser modulator 620. The mirror 610 rotates on two orthogonal axes to position the optical axis of the laser beam at any angular position within a preferred search cone or field-of-regard. Typical cone sizes may be five degrees of half an angle but may be larger or smaller depending on the specifics of the application. Mirror rotation angles are measured by a position sensor 630 and formulated as position feedback data routed to a control processor. Similarly, pointing commands from the control processor are routed to a mirror driver 640 which generates drive signals to reposition the mirror 610.

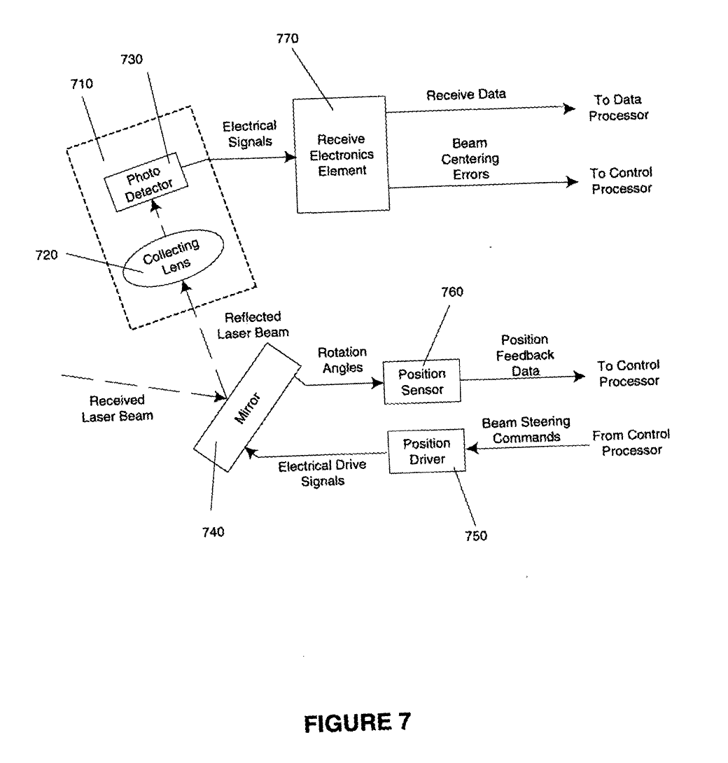

Turning now to FIG. 7, illustrated is a block diagram of an embodiment of a receiver element of a transceiver constructed according to the principles of the present invention. The receiver element includes a receiver aperture (also referred to as an optical detector assembly) 710 such as a fixed optical detector assembly having a collecting lens 720 and a photo detector 730 for converting optical energy to electrical signals. A mirror (e.g., a two-axis steerable mirror) 740, similar to that of a mirror of a transmitter element but larger in diameter, is used to redirect a received laser beam along an optical axis of the receiver aperture 710. Beam steering commands are generated by a control processor to ensure that a reflected laser beam is aligned with an optical axis of the receiver aperture 710. The beam steering commands are converted to electrical drive signals by a position driver 750.

To provide closed loop control of the mirror 740, rotation angles are measured by a position sensor 760 and supplied as position feedback data to the control processor. The electrical signals from the photo detector 730 are processed by a receive electronics element 770 to demodulate receive data that is routed back to a data processor. By incorporating additional detectors, the receive electronics element 770 may also derive beam centering errors that may be provided to the control processor.

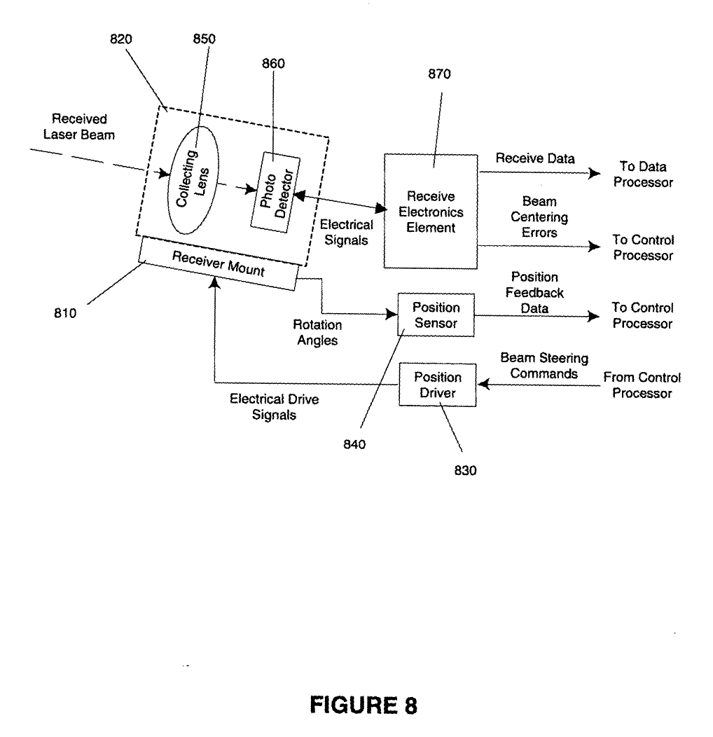

Turning now to FIG. 8, illustrated is a block diagram of another embodiment of a receiver element of a transceiver constructed according to the principles of the present invention. The receiver element includes a two-axis rotating receiver mount 810 for a receiver aperture (also referred to as an optical detector assembly) 820 in lieu of a steerable mirror system. In the illustrated embodiment, a control processor generates beam steering commands to cause the receiver mount 810 to align an optical axis of the receiver aperture 820 to a received laser beam. The beam steering commands are converted by a position driver 830 to electrical drive signals to rotate the two-axis rotating receiver mount 810. The resulting rotation angles of the two-axis rotating receiver mount 810 are measured by a position sensor 840 and routed back to the control processor as position feedback data.

A collecting lens 850 is aligned orthogonally to an incoming laser beam and focuses the received energy on a photo detector 860 wherein the optical energy is converted to electrical signals. A receive electronics element 870 demodulates the received electrical signals to recover receive data that is routed to a data processor. By incorporating additional detectors, the receive electronics element 870 may also derive beam centering errors that may be provided to the control processor.

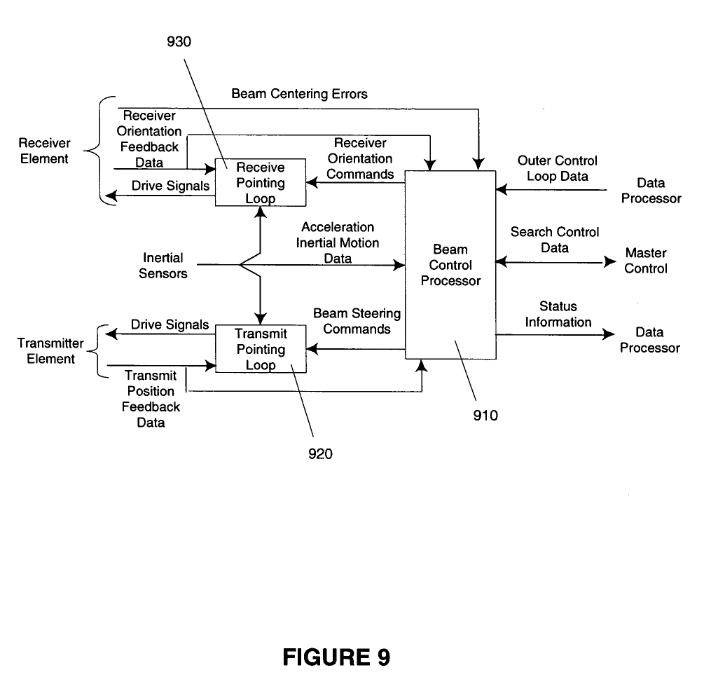

Turning now to FIG. 9, illustrated is a block diagram of an embodiment of a control processor of a transceiver constructed according to the principles of the present invention. The control processor includes a beam control processor 910, transmit pointing loop 920 and a receive pointing loop 930. The beam control processor 910 implements logic and algorithms for acquisition and tracking of the other transceivers in an optical wireless network based on, for instance, acceleration inertial motion data, beam centering errors, and outer control loop data received, in part, from an other transceiver. Beam pointing during acquisition is controlled by search control data provided by a master control function as described, for instance, in U.S. patent application Ser. No. 10/409,918 entitled “Wireless Optical System and Method for Point to Point High Bandwidth Communications” to McMurry, et al.

Beam steering commands are supplied to the transmit pointing loop 920 which employs proportional, integral, and derivative compensation methods as necessary to provide stable, accurate positioning of a mirror in a transmitter element of a transceiver. As those skilled in the art understand, characteristics of the proportional, integral, and derivative compensation loop design depend on the specific components selected for the transmitter element and for requirements of a particular application. A function of the transmit pointing loop 920 is to generate drive signals to position the mirror such that the transmit position feedback data follows the beam steering commands. The acceleration inertial motion data are also available directly to the transmit pointing loop 920 as needed to accomplish inertially stabilized positioning and pointing.

Similarly, receiver orientation commands are supplied to the receive pointing loop 930 to maintain an optical axis of a receiver element of a transceiver co-linear with a line-of-sight of an other transceiver. The receiver pointing loop 930 also employs proportional, integral, and derivative compensation methods to generate drive signals to rotate the receiver element in two axes in such a manner that the receiver orientation feedback data follows the receiver orientation commands. The beam control processor 910 also generates status information such as tracking status and a residual base motion portion of the outer control loop data that is supplied to an other transceiver via the data processor.

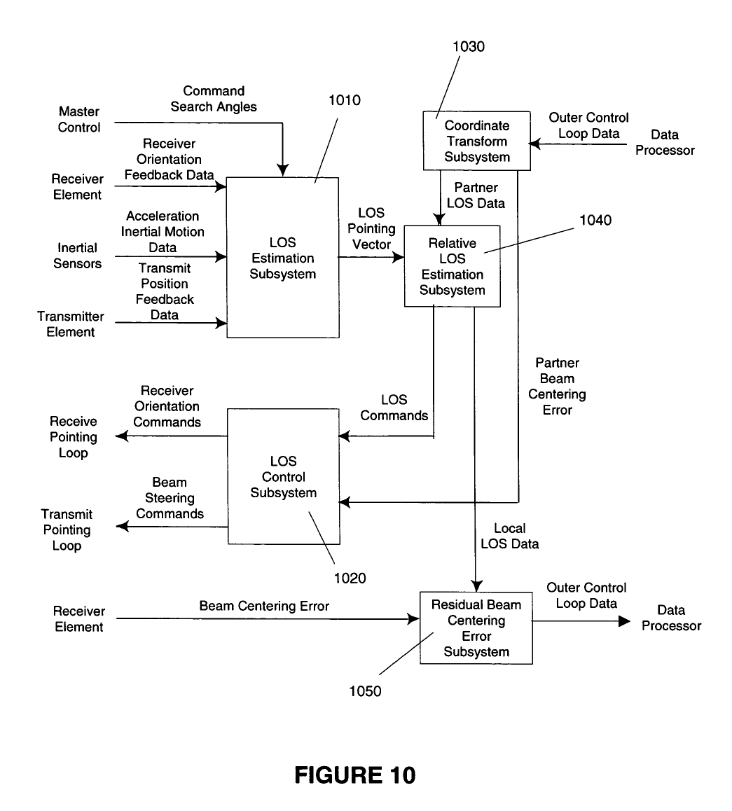

Turning now to FIG. 10, illustrated is a block diagram of an embodiment of a beam control processor of a control processor of a transceiver constructed according to the principles of the present invention. The beam control processor includes signal processing and control algorithms for the beam control functions to establish and maintain an optical wireless link between two transceivers of an optical wireless network. The beam control processor includes a LOS estimation subsystem 1010 and a LOS control subsystem 1020. Each transceiver continuously monitors system data to define and update an estimate of the respective LOS pointing vector in a reference frame fixed to a housing of the transceiver. The LOS estimation subsystem 1010 blends acceleration inertial motion data, receiver orientation feedback data, and transmit position feedback data to estimate the LOS pointing vector including line-of-sight angles and angular rates based on a current position of the transceiver and any base motion. During a search mode, the LOS estimation subsystem 1010 incorporates command search angles to direct a line-of-sight in the process of locating and acquiring the other transceiver.

Once the other transceiver is acquired and an optical wireless link is established therebetween (refer, for instance, to U.S. patent application Ser. No. 10/409,918 entitled “Wireless Optical System and Method for Point to Point High Bandwidth Communications” to McMurry, et al.), a line-of-sight control necessitates compensating for the motion of both of the transceivers. The other transceiver uses an established optical wireless link as an outer control loop to provide data about a line-of-sight pointing data of a laser beam thereof and any inertial motion that the other transceiver may be experiencing. That information is demodulated by a data processor and processed by a coordinate transform subsystem 1030 to convert to the local transceiver's reference frame. The resulting line-of-sight data about the other transceiver (a partner LOS data) is combined with the LOS pointing vector by a relative LOS estimation subsystem 1040 to define a line-of-sight between the two transceivers in a local reference frame. Any corrections to align the local line-of-sight with the relative line-of-sight are generated and routed to the LOS control subsystem 1020 as LOS commands.

The LOS control subsystem 1020 combines the LOS commands with a beam center error associated with the other transceiver (a partner beam centering error) to generate beam steering commands for a transmit pointing loop and receiver orientation commands for a receive pointing loop. In addition, the LOS control subsystem 1020 provides additional beam steering corrections for the transmit pointing loop to compensate for any beam displacement error at a receiver aperture of the other transceiver. The partner beam centering error is transmitted by the other transceiver over an optical wireless link as part of the outer control loop data and is converted to the local coordinate reference frame.

To complete an outer control loop process, the transceiver combines local LOS data with a beam centering error in a residual beam centering error subsystem 1050 to determine a residual beam centering error to be shared with the other transceiver. The residual beam centering error subsystem 1050 adjusts the beam centering error for orientation corrections made locally and dynamic relative line-of-sight motions since the measurement was obtained. The resulting outer control loop data is then routed to a data processor for transmission to the other transceiver.

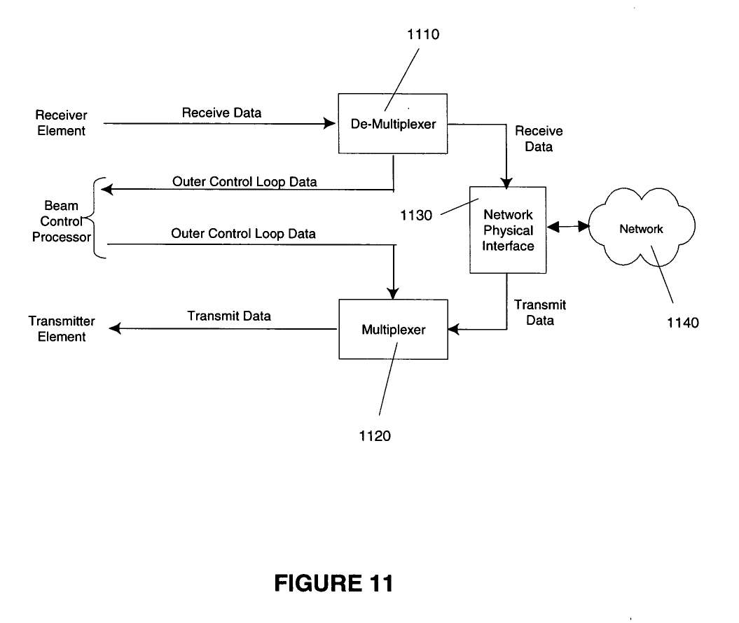

Turning now to FIG. 11, illustrated is a block diagram of an embodiment of a data processor of a transceiver constructed according to the principles of the present invention. The data processor includes de-multiplexer 1110 to remove outer control loop data from a receive data transmitted by an other transceiver. The data processor also includes a multiplexer 1120 that injects the outer control loop data into a transmit data that is to be sent to the other transceiver. A network physical interface 1130 of the data processor provides physical and electrical connectivity of the transceiver to the media of a communication network 1140 (e.g., a local area network). Data from the communication network 1140 is transmitted over an optical wireless link to an other transceiver. Data received from the other transceiver is sent to the communication network 1140. The network physical interface 1130 provides media dependent connectivity to the communication network 1140 and allows the systems herein to operate independent of the particular protocols or signaling methods.

The following references are submitted for background information on optical networks and systems and subsystems therein, namely, U.S. Pat. No. 5,237,450 entitled “Inertial Stabilizing System,” issued Aug. 17, 1993 to Stromberg; U.S. Pat. No. 6,348,986 entitled “Wireless Fiber-Coupled Telecommunication Systems Based on Atmospheric Transmission of Laser Signals,” issued Feb. 19, 2002 to Doucet, et al.; U.S. Pat. No. 6,483,621 entitled “Method and Apparatus for Tone Tracking in Wireless Optical Communication Systems,” issued Nov. 19, 2002 to Adams, et al.; U.S. Pat. No. 6,493,490 entitled “Method and Apparatus for Receiving and Aligning an Optical Communications Beam with an Integrated,” issued Dec. 10, 2002 to Steiger; and U.S. Pat. No. 6,609,037 entitled “Gimbal Pointing Vector Stabilization Control System and Method,” issued Aug. 19, 2003 to Bless, et al. The aforementioned references are incorporated herein by reference.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the systems and subsystems of the transceiver may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A beam control processor for use with a transceiver employing an inertial sensor and capable of transmitting a laser beam to an other transceiver, comprising:
a line-of-sight estimation subsystem configured to provide a line-of-sight pointing vector of said laser beam based on acceleration inertial motion data provided by said inertial sensor; and
a line-of-sight control subsystem configured to generate beam steering commands for said transceiver as a function of said line-of-sight pointing vector.

2. The beam control processor as recited in claim 1 wherein said line-of-sight estimation subsystem is configured to provide said line-of-sight pointing vector of said laser beam based on receiver orientation feedback data and transmit position feedback data associated with said transceiver.

3. The beam control processor as recited in claim 1 further comprising a coordinate transform subsystem configured to provide line-of-sight data about said other transceiver based on outer control loop data including a line-of-sight pointing data and an inertial motion of said other transceiver.

4. The beam control processor as recited in claim 3 further comprising a relative line-of-sight estimation subsystem configured to provide line-of-sight commands based on said line-of-sight data about said other transceiver and said line-of-sight pointing vector associated with said transceiver.

5. The beam control processor as recited in claim 4 wherein said line-of-sight control subsystem is configured to provide said beam steering commands based on said line-of-sight commands and a beam center error associated with said other transceiver.

6. The beam control processor as recited in claim 1 further comprising a residual beam centering error subsystem configured to provide outer control loop data based on line-of-sight data and a beam centering error of said transceiver.

7. The beam control processor as recited in claim 1 wherein said line-of-sight control subsystem is configured to provide receiver orientation commands as a function of said line-of-sight pointing vector.

8. A method of providing beam steering commands for use with a transceiver employing an inertial sensor and capable of transmitting a laser beam to an other transceiver, comprising:
providing a line-of-sight pointing vector of said laser beam based on acceleration inertial motion data provided by said inertial sensor; and
generating beam steering commands for said transceiver as a function of said line-of-sight pointing vector.

9. The method as recited in claim 8 wherein said providing said line-of-sight pointing vector of said laser beam is based on receiver orientation feedback data and transmit position feedback data associated with said transceiver.

10. The method as recited in claim 8 further comprising providing line-of-sight data about said other transceiver based on outer control loop data including a line-of-sight pointing data and an inertial motion of said other transceiver.

11. The method as recited in claim 10 further comprising providing line-of-sight commands based on said line-of-sight data about said other transceiver and said line-of-sight pointing vector associated with said transceiver.

12. The method as recited in claim 11 wherein said generating said beam steering commands is based on said line-of-sight commands and a beam center error associated with said other transceiver.

13. The method as recited in claim 8 further comprising providing outer control loop data based on line-of-sight data and a beam centering error of said transceiver.

14. The method as recited in claim 8 further comprising generating receiver orientation commands as a function of said line-of-sight pointing vector.

15. A transceiver, comprising:
a housing that provides a foundation for said transceiver;
an inertial sensor, coupled to said housing, configured to provide acceleration inertial motion data associated with said transceiver;
a transmitter element configured to transmit a transmitted laser beam to an other transceiver;
a receiver element configured to receive a received laser beam from an other transceiver; and
a control processor, coupled to said transmitter and receiver elements, configured to provide beam steering control for said transmitter element and orientation control for said receiver element, including:
a beam control processor, including:
a line-of-sight estimation subsystem configured to provide a line-of-sight pointing vector of said transmitted laser beam based on acceleration inertial motion data provided by said inertial sensor, and
a line-of-sight control subsystem configured to generate beam steering commands for said transmitter element as a function of said line-of-sight pointing vector.

16. The transceiver as recited in claim 15 wherein said line-of-sight estimation subsystem is configured to provide said line-of-sight pointing vector of said transmitted laser beam based on receiver orientation feedback data and transmit position feedback data associated with said transceiver.

17. The transceiver as recited in claim 15 wherein said beam control processor further comprises a coordinate transform subsystem configured to provide line-of-sight data about said other transceiver based on outer control loop data including a line-of-sight pointing data and an inertial motion of said other transceiver.

18. The transceiver as recited in claim 17 wherein said beam control processor further comprises a relative line-of-sight estimation subsystem configured to provide line-of-sight commands based on said line-of-sight data about said other transceiver and said line-of-sight pointing vector associated with said transceiver.

19. The transceiver as recited in claim 18 wherein said line-of-sight control subsystem is configured to provide said beam steering commands based on said line-of-sight commands and a beam center error associated with said other transceiver.

20. The transceiver as recited in claim 15 wherein said beam control processor further comprises a residual beam centering error subsystem configured to provide outer control loop data based on line-of-sight data and a beam centering error of said transceiver.

21. The transceiver as recited in claim 15 wherein said line-of-sight control subsystem is configured to provide receiver orientation commands as a function of said line-of-sight pointing vector.
